(19) United States
(12) Patent Application Publication
(10) Pub. No.: US 2025/0021381 A1
(43) Pub. Date: Jan. 16, 2025

(54) METHODS, SYSTEMS, ARTICLES OF MANUFACTURE AND APPARATUS TO GENERATE DYNAMIC COMPUTING RESOURCE SCHEDULES

(71) Applicant: Intel Corporation, Santa Clara, CA (US)

(72) Inventors: Sangeeta Manepalli, Chandler, AZ (US); Chia-Hung S. Kuo, Folsom, CA (US); Venkateshan Udhayan, Portland, OR (US); Stanley Baran, Chandler, AZ (US); Jason Tanner, Folsom, CA (US); Michael Rosenzweig, Queen Creek, AZ (US)

(73) Assignee: Intel Corporation, Santa Clara, CA (US)

(21) Appl. No.: 18/902,104

(22) Filed: Sep. 30, 2024

(51) Int. Cl. G06F 9/48

(52) U.S. Cl. CPC G06F 9/4881

(57) ABSTRACT

Methods, systems, articles of manufacture and apparatus are disclosed to generate dynamic computing resource schedules. An example apparatus includes interface circuitry, machine-readable instructions, and at least one processor circuit to be programmed by the machine-readable instructions to determine a first schedule policy based on (a) an interval parameter and (b) an energy budget parameter, the first schedule policy to include a first instantiation window. The example instructions further determine performance metrics of a target processor circuit based on instantiating a workload with the first schedule policy, and generate a second schedule policy based on the performance metrics of the target processor circuit, the second schedule policy to include a second instantiation window, the second instantiation window including a modification relative to the first instantiation window.

### BACKGROUND

In recent years, computing resources have been expected to support a diverse suite of applications and tasks associated with such applications. The computing resources may be expected to support productivity applications, gaming applications, artificial intelligence (AI) applications, and video streaming applications, to name a few.

### BRIEF DESCRIPTION OF THE DRAWINGS

FIG. 1 is a block diagram of an example environment in which example schedule management circuitry operates to generate computing resource schedules.

FIG. 2 is a block diagram of an example implementation of the schedule management circuitry of FIG. 1.

FIG. 3A is a timing diagram of an example baseline scheduling policy generated by the example schedule management circuitry of FIGS. 1 and 2.

FIG. 3B is a timing diagram of an example revised scheduling policy generated by the example schedule management circuitry of FIGS. 1 and 2.

FIGS. 4 and 5 are flowcharts representative of example machine readable instructions and/or example operations that may be executed, instantiated, and/or performed by example programmable circuitry to implement the schedule management circuitry 102 of FIG. 2.

FIG. 6 is a block diagram of an example processing platform including programmable circuitry structured to execute, instantiate, and/or perform the example machine readable instructions and/or perform the example operations of FIGS. 4-5 to implement the schedule management circuitry 102 of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Operating system (OS) schedulers are driven by deadlines that are established based on application quality of service (QoS) parameters and priority parameters. However, schedules determined and/or otherwise established by OS schedulers do not consider status information associated with underlying computational resources, such as load status associated with an ability to perform tasks associated with the application. Absent feedback from the computational resources (e.g., circuits, processors, accelerators, system-on-chip (SoC) assemblies, etc.), poor performance of the application may result if other applications are also making demands on an already overloaded computational resource(s).

Examples disclosed herein facilitate consideration of target computational resource characteristics when generating a schedule policy. As used herein, a “schedule policy” is a data structure that includes one or more scheduling intervals for particular workloads (e.g., applications) to execute on computational resources. Example scheduling intervals are sometimes referred to herein as scheduling windows and are defined by and/or otherwise bounded by an initial trigger and an end trigger. As described in further detail below, a schedule policy includes execution boundaries for various workloads that define expected durations of execution. As described in further detail below, a schedule policy includes one or more idle time windows in which the computational resources are expected to operate in a relatively lower power state as compared to power states that occur during workload execution. Examples disclosed herein consider capabilities of the target computational resources and power management characteristics to generate dynamic schedule policies. As described in further detail below, initial and/or otherwise early schedule policies are referred to as baseline schedule policies when information (e.g., hints) from platform resources and activity is limited and/or otherwise unavailable. However, and as described in further detail below, examples disclosed herein cultivate information from different sources to revise a schedule policy in view of current conditions. Examples disclosed herein facilitate telemetry from the target computational resources to OS scheduling circuitry to provide constant feedback to allow dynamic generation of the schedule policies. Generally speaking, known scheduling systems lack certain types of information and/or hints to allow dynamic schedule policy generation.

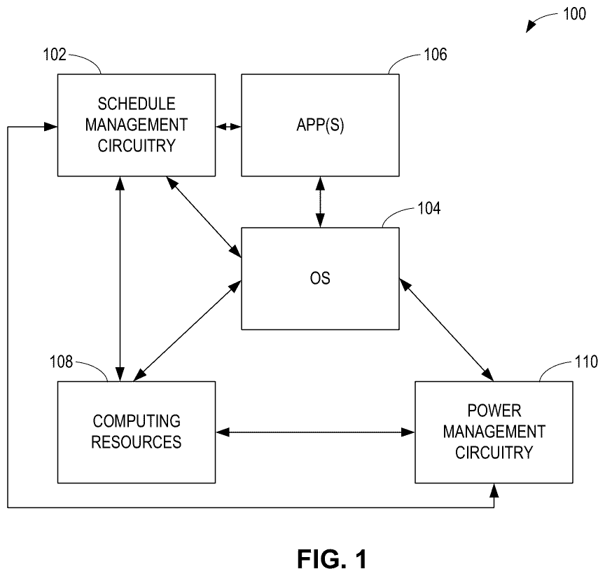

FIG. 1 is a block diagram of an example environment 100 in which example schedule management circuitry 102 operates to generate computing schedule policies. In the illustrated example of FIG. 1, the environment 100 includes an OS 104, applications 106, computing resources 108, and power management circuitry 110. In some examples, the power management circuitry 110 is referred to as a power management unit (P_{UNIT}). The example schedule management circuitry 102 is communicatively coupled to the OS 104, the applications 106, the computing resources 108, and the power management circuitry 110 to, in part, cultivate and/or otherwise acquire information used to generate dynamic computing schedule policies. The example OS 104 is communicatively coupled to the applications 106, the power management circuitry 110, and the computing resources 108, and the power management circuitry 110 is communicatively coupled to the computing resources 108. In some examples, the schedule management circuitry 102 is referred to as a scheduling circuit. In some examples, one or more scheduling tasks may be offloaded and/or otherwise processed by an external scheduler, such as the OS 104.

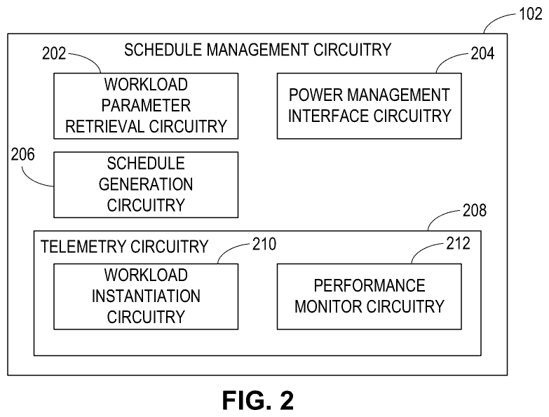

FIG. 2 is a block diagram of an example implementation of the schedule management circuitry 102 of FIG. 1 to do computing resource schedule policy generation. The schedule management circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the schedule management circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

FIG. 2 is a block diagram of the example schedule management circuitry 102 of FIG. 1. In the illustrated example of FIG. 2, the schedule management circuitry 102 includes example workload parameter retrieval circuitry 202, example power management interface circuitry 204, example schedule generation circuitry 206, and example telemetry circuitry 208. The telemetry circuitry 208 includes example workload instantiation circuitry 210 and example performance monitor circuitry 212.

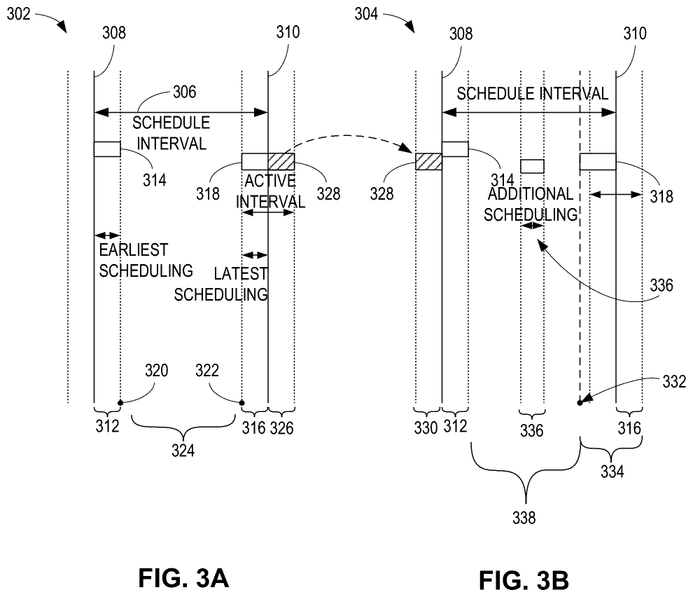

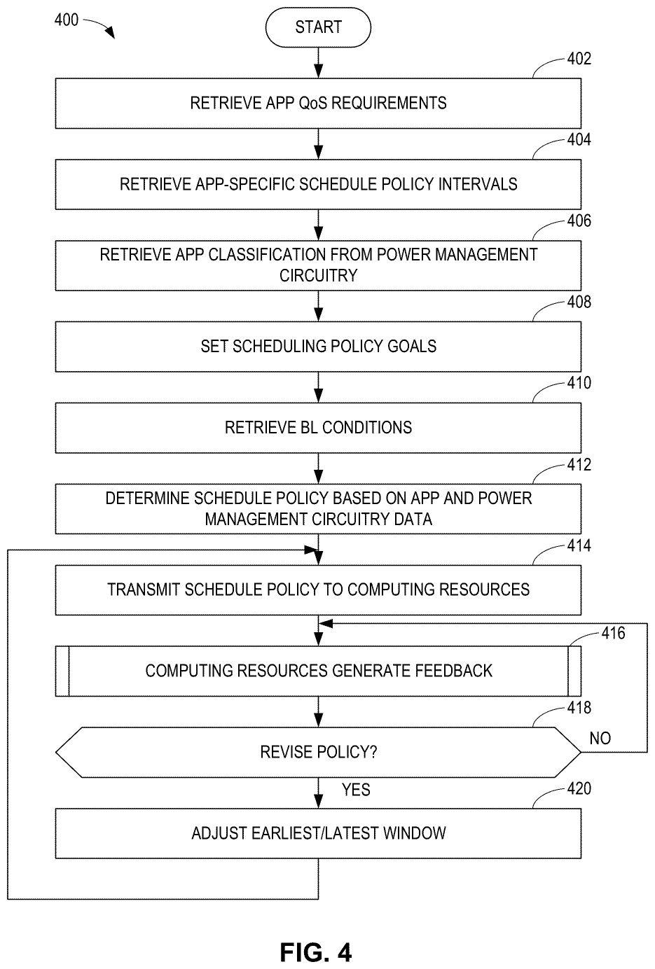

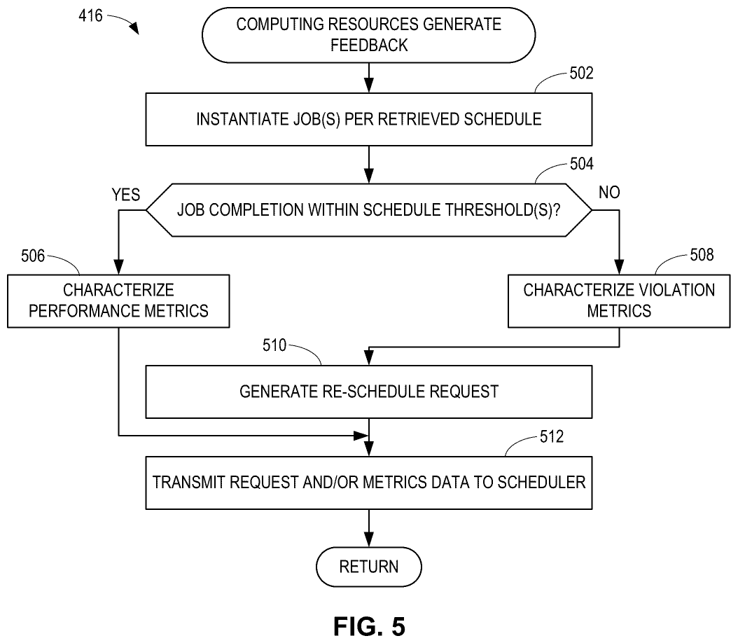

In some examples, the parameter retrieval circuitry 202 is instantiated by programmable circuitry executing parameter retrieval instructions, the power management interface circuitry 204 is instantiated by programmable circuitry executing power management interfacing instructions, the schedule generation circuitry 206 is instantiated by programmable circuitry executing schedule generation instructions, the telemetry circuitry 208 is instantiated by programmable circuitry executing telemetry instructions, the workload instantiation circuitry 210 is instantiated by programmable circuitry executing workload instantiation instructions, and the performance monitor circuitry 212 is instantiated by programmable circuitry executing performance monitoring instructions. The aforementioned circuitry is configured to perform operations such as those represented by the flowchart(s) of FIGS. 3-4.

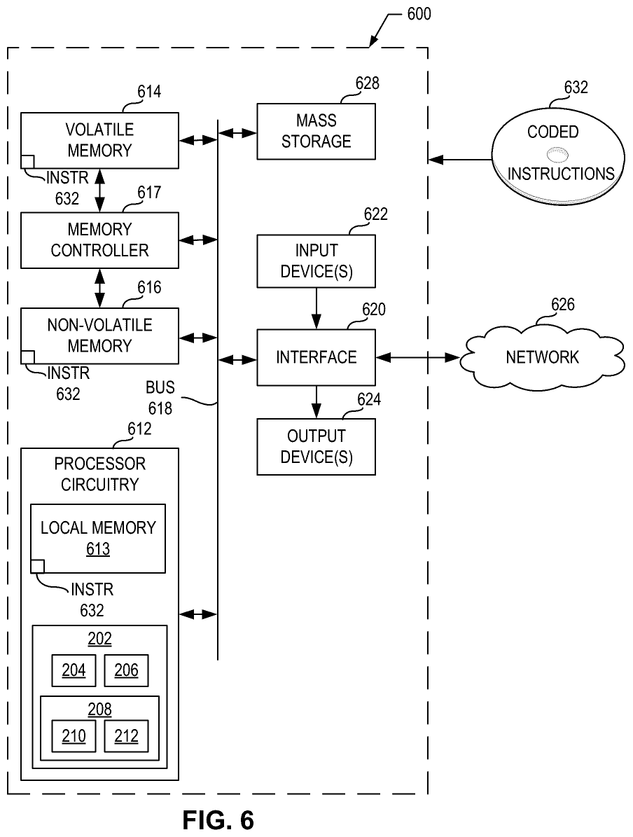

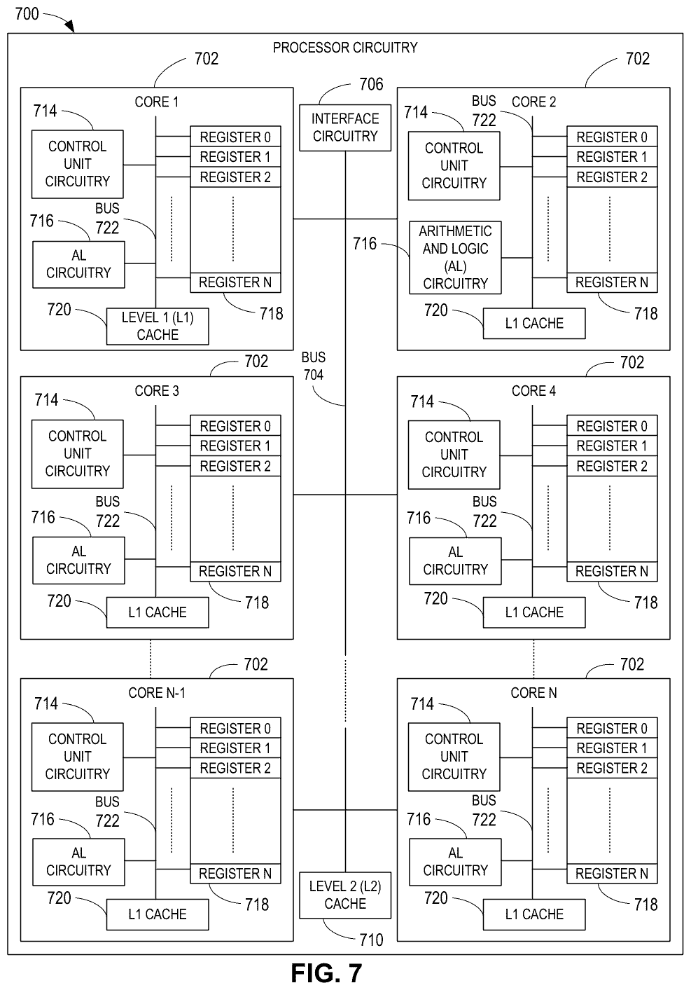

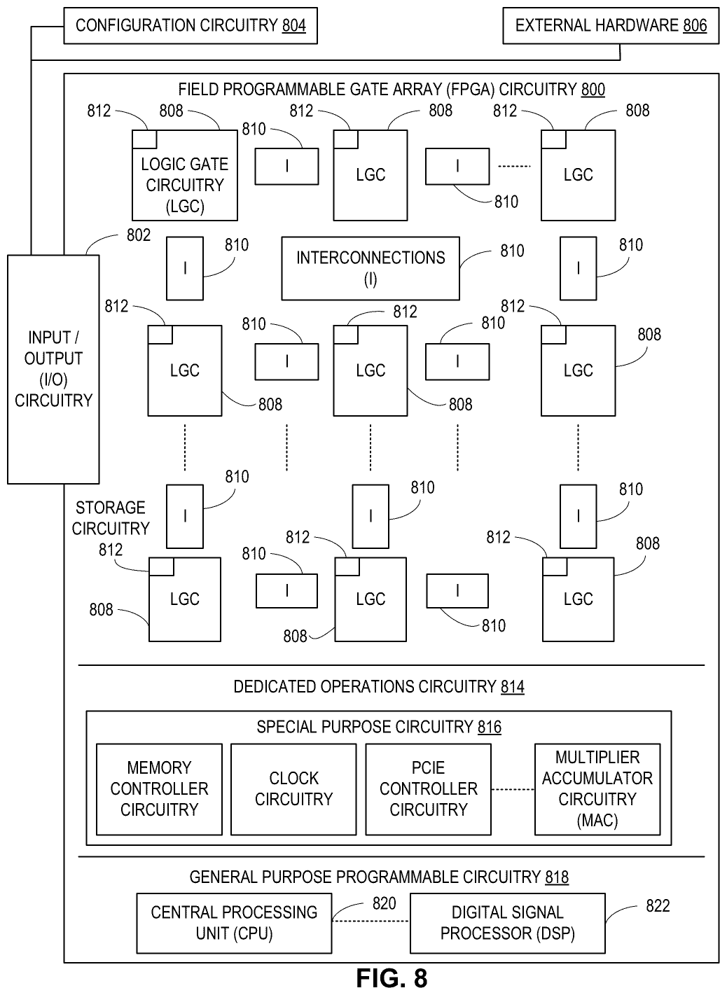

In some examples, the schedule management circuitry 102 includes means for workload parameter retrieval, means for power management, means for schedule generation, means for telemetry, means for workload instantiation, means for performing monitoring, and means for schedule management. For example, the means for workload parameter retrieval may be implemented by the example workload parameter retrieval circuitry 202. The means for power management may be implemented by the example power management interface circuitry 204. The means for schedule generation may be implemented by the example schedule generation circuitry 206. The means for telemetry may be implemented by the example telemetry circuitry 208. The means for workload instantiation may be implemented by the example workload instantiation circuitry 210. The means for performing monitoring may be implemented by the example performance monitor circuitry 212, and the means for schedule management may be implemented by the example schedule management circuitry 102. In some examples, the aforementioned circuitry may be instantiated by programmable circuitry such as the example programmable circuitry 612 of FIG. 6. For instance, the aforementioned circuitry may be instantiated by the example microprocessor 700 of FIG. 7 executing machine executable instructions such as those implemented by at least blocks of FIGS. 4-5. In some examples, the aforementioned circuitry may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In operation, the example workload parameter retrieval circuitry 202 retrieves quality of service (QoS) requirements (e.g., parameters, expectations) from the application that is requesting services, such as QoS requirements in the form of metadata from the application 106. In some examples, the application 106 includes metadata that specifies a particular type of computing resource, a particular latency threshold after a request to instantiate the application 106, a particular priority parameter (e.g., a first application having a “critical” priority value (e.g., a relatively high value) would get instantiation priority over a second application having a relatively less critical (e.g., lower) priority value), etc. The example workload parameter retrieval circuitry 202 retrieves application-specific scheduling interval parameter information (e.g., an interval parameter value indicative of a duration of time that hardware resources should be available to the application) that, if followed, maintain QoS expectations for a user during application execution. For example, some applications identify a first scheduling interval that, if maintained, ensure the application performs in a manner that is acceptable and/or otherwise expected by a user. To illustrate, users of a video conference application typically expect to conduct voice, video and/or instant messaging tasks without human-perceived delay or jitter.

As such, the workload parameter retrieval circuitry 202 retrieves a scheduling interval value of, for example, 20 mSec. In other examples, the workload parameter retrieval circuitry 202 retrieves a scheduling interval value that corresponds to a threshold number of frames per unit of time (e.g., 10 frames of video per second). In some examples, the workload parameter retrieval circuitry 202 retrieves a scheduling interval value of 8 mSec, which suggests an application with a relatively higher demand, such as a gaming application in which delay or lag is unacceptable. Stated differently, some applications expect more frequent opportunities to utilize available computing resources, thereby resulting in a relatively faster scheduling interval configuration (e.g., 8 mSec for a gaming application) as compared to a relatively slower scheduling interval configuration (e.g., 20 mSec for a video conferencing application).

The power management interface circuitry 204 retrieves an application classification parameter from the example power management circuitry 110. For example, power management circuitry 110 typically operates in cooperation with the particular type of computing resources 108 to establish and/or otherwise control a mode of operation, which affects an energy consumption rate of the computing resources 108. In some examples, the mode of operation or classification is referred to as an energy budget parameter. Example modes of operation include a performance mode associated with applications that expect a relatively robust computing resource device (e.g., cryptography applications, artificial intelligence (AI) applications, etc.), while a battery-life mode is associated with an application that attempts to conserve power (e.g., mobile devices powered by batteries). An example sustained mode is associated with applications that do not typically exhibit transient resource demands and/or otherwise operate in a steady state, unlike a bursty mode in which varied amounts of computing resource demand are frequent and/or otherwise expected. In some examples, the mode or classification established by the power management circuitry 110 configures the computing resources 108 to operate at a particular frequency so that the performance of the application 106 satisfies expected QoS parameters. Examples disclosed herein consider such information when generating dynamic computing schedule policies.

The power management interface circuitry 204 sets and/or otherwise establishes an operational goal based on the previously determined mode or classification. For example, in the event of a battery-life classification, the power management interface circuitry 204 sets a goal to maximize an idle time of the target computing resources 108. However, in the event of a performance classification, the power management interface circuitry 204 sets a goal to minimize the idle time of the target computing resources 108 so that application responsivity is aligned with QoS parameters (e.g., gaming applications).

However, examples disclosed herein acknowledge that an operational goal may be a premature task if other relevant information is not considered. For instance, assuming a “performance” classification is established at a first time, if battery conditions are relatively low (e.g., at or below 20%) then such a classification may result in poor and/or otherwise inoperable application behavior and/or accelerated loss of device power as a result of neglecting an already-low battery capacity metric. Reiterating at least one objective of examples disclosed herein, hints from various aspects of the environment 100 of FIG. 1, when considered in the aggregate, facilitate generation of a dynamic computing schedule policy. The example power management interface circuitry 204 retrieves battery conditions to set an operational goal in one of an aggressive energy conservation mode (e.g., when battery capacity conditions satisfy a threshold value indicative of low capacity, such as 20% battery capacity remaining), a relaxed energy conservation mode (e.g., when battery capacity conditions satisfy a threshold value indicative of abundant capacity, e.g., 50% battery capacity remaining), or a balance/hybrid energy conservation mode.

The example schedule generation circuitry 206 determines and/or otherwise generates a schedule policy based on available information associated with the environment 100 prior to execution of the application 106. In particular, the schedule generation circuitry 206 generates the schedule policy as a first schedule policy at a first time that is based on the application 106 QoS requirements described above (e.g., a particular priority value, such as an integer value “1” for a relatively low priority, or an integer value of “9” for a relatively high/critical priority), the application-specific scheduling interval(s) described above, the application classification parameter (e.g., mode of operation) described above, the operational goal described above, and the battery conditions of the device to execute the application 106. In some examples, the first schedule policy at the first time is referred to as a standard and/or otherwise baseline schedule policy, an example of which is shown in FIG. 3.

FIG. 3A is an example baseline schedule policy 302, and FIG. 3B is an example revised schedule policy 304. The schedule generation circuitry 206 generates the baseline schedule policy 302 based on available information associated with the environment 100 prior to execution of the application 106. In the illustrated example of FIG. 3A, the baseline schedule policy 302 includes a baseline schedule interval 306 that is defined by a duration between an initial trigger 308 and an end trigger 310. The example initial trigger 308 represents an earliest possible time in which the application 106 may be instantiated, and the example end trigger 310 represents a latest possible time in which the application 106 may be instantiated for each iteration of the schedule interval 306. Generally speaking, the schedule interval 306 is a time window and/or otherwise a duration in which one or more applications may be instantiated. Unlike known scheduling techniques that establish a rigorous and/or otherwise static timestamp in which a particular application must be instantiated, examples disclosed herein generate a continuum of instantiation opportunities within the time window 306.

The example schedule generation circuitry 206 generates one or more execution boundaries that represent portions of the schedule interval 306 in which applications should be instantiated and execute. In the illustrated example of FIG. 3A, a first execution boundary 312 (e.g., a first instantiation window) represents an earliest scheduling instantiation range for a first application 314. The illustrated example of FIG. 3A also includes a second execution boundary 316 (e.g., a second instantiation window) that represents a latest scheduling instantiation range for a second application 318. In some examples, the schedule generation circuitry 206 assigns the first execution boundary 312 for the first application 314 based on a particular priority associated with the first application 314, such as an application having a relatively high priority that should be serviced as early as possible within each iteration of the schedule interval 306. Conversely, the schedule generation circuitry 206 may assign the second execution boundary 316 for the second application 318 based on a relatively low priority designation. A tail end 320 of the first execution boundary 312 and a leading end 322 of the second execution boundary 316 establish an idle time window 324. Generally speaking, the schedule generation circuitry 206 assigns the execution boundaries in a manner that maximizes a duration of the idle time window 324, which permits and/or otherwise causes idle time for the target computing resource(s) that execute the one or more applications 106. During the idle time window 324, the target computing resource(s) may enter a sleep mode.

The telemetry circuitry 208 transmits and/or otherwise sends the baseline schedule policy 302 (e.g., as a data structure) to the target computing resource 108. In some examples, the target computing resource 108 includes an application programming interface (API) to receive information from the example schedule management circuitry 102 to allow the exchange of telemetry information to be used for schedule policy generation and real-time operational feedback of performance metrics of the computing resource 108. Based on the baseline schedule policy 302, the workload instantiation circuitry 210 instantiates the application(s) 106 and/or tasks/jobs/workloads associated with the application(s) 106. The example performance monitor circuitry 212 monitors the behavior of the job to determine whether it executes within the established parameters of the baseline schedule policy 302. For instance, in the illustrated example of FIG. 3A the second application 318 (and/or tasks/jobs/workloads associated therewith) is scheduled to be instantiated at the leading end 322 of the second execution boundary 316. However, during runtime the performance monitor circuitry 212 determines that the second application 318 exhibits an execution drift 326 for a period of time (e.g., a number of milliseconds) after the end trigger 310. The performance monitor circuitry 212 logs such events as a violation metric. While the performance monitor circuitry 212 detects and logs execution drift instances, examples disclosed herein are not limited thereto. Violation metrics include, but are not limited to boundary drift counts (e.g., a number of instances per unit of time in which a boundary drift occurs), leading edge boundary drift instances, trailing edge boundary drift instances, QoS metric violations, instantiation violation instances of a workload based on an instantiation timestamp that does not satisfy an instantiation threshold (e.g., a threshold for a particular instantiation window), and/or memory interactions between the target computing resource(s) 108 and memory devices. In some examples, the instantiation threshold is based on a type of a target computing resource. The performance monitor circuitry 212 characterizes the performance metrics, and the telemetry circuitry 208 generates a re-schedule request in the event violation metrics satisfy one or more threshold conditions.

The example schedule generation circuitry 206 receives the re-schedule request and determines whether to revise the baseline schedule policy 302. If so (e.g., based on execution drift instances), the schedule generation circuitry 206 adjusts one or more of the first execution boundary 312 and/or the second execution boundary 316 in an effort to reduce the violation metrics. As shown in the illustrated example of FIG. 3B, the execution drift 326 associated with a portion 328 of the second application 318 that consumes execution time beyond its intended duration and encroaches a boundary 330 prior to a second iteration of the scheduling interval 306. Stated differently, an initial amount of time allocated to the second application 318 was not long enough for that second application 318 to fully instantiate and complete within the second execution boundary 316. To reduce a likelihood of execution boundary violations, the schedule generation circuitry 206 generates an alternate second execution boundary 334 that is defined by an alternate leading end 332. As such, the example second application 318 may complete its tasks within the relatively longer duration defined by the alternate second execution boundary 334. At least one effect of the example adjustment is that a second and/or otherwise alternate idle time window 338 is less than the initial idle time window 324 described above in connection with FIG. 3A.

While the alternate second execution boundary 334 of FIG. 3B encroaches and/or otherwise reduces a duration of the idle time window 324 shown in FIG. 3A, example generation of dynamic schedule policies disclosed herein is able to reduce performance violations and more efficiently allocate utilization of the computing resources 108 by, in part, considering a relatively greater amount of available information from the computing resources 108 performance, the power management circuitry 110, and the application 106. In some examples, the schedule generation circuitry 206 generates an additional schedule boundary 336 in the event that one or more tasks are discovered during subsequent iterations of the baseline schedule policy 302 and/or the revised schedule policy 304. For instance, the application 106 that is executing tasks may have a first set of tasks at a first time of instantiation and a second (e.g., alternate and/or additional) set of tasks at a second time of instantiation.

Considering an example use case scenario with a productivity meeting conference application (e.g., a first application to be executed by the computing resources 108, a background artificial intelligence (AI) application (e.g., a second application to be executed by the computing resources 108), and a gaming application (e.g., a third application to be executed by the computing resources 108). As described above, examples disclosed herein cultivate information associated with QoS requirements of the applications. For instance, the productivity meeting conference application (e.g., the first application) may include QoS parameters associated with streaming capabilities, and the gaming application may include QoS parameters associated with real-time performance capabilities, which are a relatively more aggressive set of expectations for the computing resources 108. In some examples, the QoS parameters associated with the productivity meeting conference application require at least 15 frames-per-second (fps) video rendering performance, and the QoS parameters associated with the gaming application require at least 60 fps video rendering performance.

In addition to cultivating QoS expectations from one or more applications 106, examples disclosed herein cultivate information from the power management circuitry 110 to establish a mode of operation for the computing resources 108. For instance, the productivity meeting conference application is defined by the power management circuitry 110 with a battery-life classification (e.g., a power saving mode) to seek a goal of maximizing an idle time for the computing resources 108. However, the gaming application is defined by the power management circuitry 110 with a high-performance classification (e.g., a high-performance mode) to seek a goal of minimizing an idle time for the computing resources 108. While known approaches to structure and/or otherwise configure an operational mode of computing resources default to a maximum performance level in view of applications having competing performance goals, examples disclosed herein facilitate granular control of operational modes of the computing resources 108 during iterations of schedule operation.

Additionally, examples disclosed herein further tailor and/or customize the scheduling policy (e.g., the example baseline scheduling policy 302, the example revised scheduling policy 304) based on battery-life (BL) (e.g., battery capacity) feedback from the example environment 100. The power management interface circuitry 204 retrieves BL conditions as a continuum in view of the possibility that environment 100 operations are dynamic and BL conditions will change over time. In particular, while a first (e.g., baseline) scheduling policy may be appropriate when generated at a first time, operating conditions of the environment 100 may exhibit new conditions that were not known and/or otherwise available at the first time. Periodic, aperiodic and/or scheduled BL condition information permits dynamic adjustments to schedule policies. In the event a rate of BL capacity is decreasing at a first threshold rate, then an originally generated schedule policy may not need to change to satisfy its objectives (e.g., a laptop executing a video conference application for a four-hour time period will be left with sufficient battery capacity). However, in the event the power management interface circuitry 204 detects a two or more BL capacity measurements and determines a second rate of decrease that is greater than the first rate of decrease, then examples disclosed herein generate an alternate (revised) schedule policy to allow scheduling objectives to be met in a manner that reduces or eliminates catastrophic results (e.g., complete BL capacity depletion after two hours of a four hour operational goal). In such circumstances, examples disclosed herein facilitate the power management interface circuitry 204 to instruct the power management circuitry 110 to place the computing resources 108 in a relatively more conservative mode to increase idle time.

While an example manner of implementing the schedule management circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example workload parameter retrieval circuitry 202, the example power management interface circuitry 204, the example schedule generation circuitry 206, the example telemetry circuitry 208, the example workload instantiation circuitry 210, the example performance monitor circuitry 212, and/or, more generally, the example schedule management circuitry 102 of FIG. 2, may be implemented by hardware alone or by hardware in combination with software and/or firmware. Thus, for example, any of the example workload parameter retrieval circuitry 202, the example power management interface circuitry 204, the example schedule generation circuitry 206, the example telemetry circuitry 208, the example workload instantiation circuitry 210, the example performance monitor circuitry 212, and/or, more generally, the example schedule management circuitry 102 of FIG. 2, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example schedule management circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the schedule management circuitry 102 of FIG. 2 and/or representative of example operations which may be performed by programmable circuitry to implement and/or instantiate the schedule management circuitry 102 of FIG. 2, are shown in FIGS. 4-5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-5, many other methods of implementing the example schedule management circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to generate dynamic computing resource schedules. The example machine-readable instructions and/or the example operations 400 of FIG. 4 begin at block 402, at which the workload parameter retrieval circuitry 202 retrieves QoS requirements from the application 106. As described above, the application 106 may include metadata that specifies different types of QoS requirements and/or preferences, such as a priority parameter. The workload parameter retrieval circuitry 202 retrieves application-specific scheduling intervals from the application 106 (block 404), such as expected time periods of activity in which the application 106 is to be serviced in between time periods of inactivity.

The power management interface circuitry 204 retrieves application classification information (e.g., the application classification parameter) from the power management circuitry 110 (block 406), and sets schedule policy goals (block 408). As described above, this initial data acquisition allows the generation of the baseline schedule policy (e.g., the baseline schedule policy 302 of FIG. 3A), which may be considered a best-guess in view of available information associated with the example environment 100. The power management interface circuitry 204 retrieves BL conditions (block 410), and the schedule generation circuitry 206 determines a baseline schedule policy based on the available information (block 412).

The telemetry circuitry 208 transmits the schedule policy (e.g., the baseline schedule policy for a first iteration of the example operations 400) to the computing resources 108 (block 414), and the computing resources 108 process jobs and generate feedback (block 416) based on the request sent by the telemetry circuitry 208. As described above and in further detail below in connection with FIG. 5, the schedule generation circuitry 206 determines whether the schedule should be revised (block 418), such as in response to a threshold quantity of performance violations detected per unit of time. If not, then control returns to block 416 to continue executing jobs associated with the application 106. However, if adjustments to the schedule are needed, the schedule generation circuitry 206 adjusts schedule parameters in an effort to reduce future violations when jobs/tasks of the application 106 are executed on the computing resources 108 (block 420).

FIG. 5 illustrates additional detail corresponding to block 416 of FIG. 4. In the illustrated example of FIG. 5, the workload instantiation circuitry 210 instantiates one or more jobs per the retrieved schedule (block 502). The performance monitor circuitry 212 determines whether the one or more jobs completed within thresholds defined by the applied schedule (block 504). If so (e.g., “YES”), the performance monitor circuitry 212 characterizes the performance metrics as acceptable (block 506), which allows the currently applied schedule to be used. However, if the performance monitor circuitry 212 detects one or more violations of the currently applied schedule (e.g., a task requires execution resources of the resources 108 outside of an assigned boundary/window) (block 504 “NO”), then the performance metrics are characterized as unacceptable and/or otherwise in violation of the currently applied schedule (block 508). The telemetry circuitry 208 generates a re-schedule request (block 510), and transmits the request and/or metrics data to a scheduler, such as the schedule generation circuitry 206 (block 512).

FIG. 6 is a block diagram of an example programmable circuitry platform 600 structured to execute and/or instantiate the example machine-readable instructions and/or the example operations of FIGS. 4-5 to implement the schedule management circuitry 102 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example workload parameter retrieval circuitry 202, the example power management interface circuitry 204, the example schedule generation circuitry 206, the example telemetry circuitry 208, the example workload instantiation circuitry 210, the example performance monitor circuitry 212, and the schedule management circuitry 102.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4-5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4-5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4-5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-5. As such, the FPGA circuitry 800 may be configured and/or structured to effectively instantiate some or all of the operations/functions corresponding to the machine readable instructions of the flowchart(s) of FIGS. 4-5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4-5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4-5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4-5 to perform first operation(s)/function(s), the FPGA circuitry 800 of FIG. 8 may be configured and/or structured to perform second operation(s)/function(s) corresponding to a second portion of the machine readable instructions represented by the flowcharts of FIG. 4-5, and/or an ASIC may be configured and/or structured to perform third operation(s)/function(s) corresponding to a third portion of the machine readable instructions represented by the flowcharts of FIGS. 4-5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

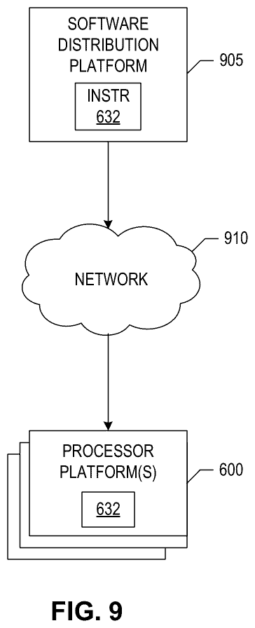

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 4-5, may be downloaded to the example programmable circuitry platform 600, which is to execute the machine readable instructions 632 to implement the schedule management circuitry 102. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable computing resource schedules to be generated in a dynamic manner and based on a relatively greater amount of available information than known scheduling techniques consider. Disclosed systems, apparatus, articles of manufacture, and methods improve the efficiency of using a computing device by generating schedules that do not default operating modes of a computing resource just by virtue of one of the tasks of an application being associated with a high-demand process in view of alternate tasks having less computational demand. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to generate dynamic computing resource schedules are disclosed herein. Further examples and combinations thereof include the following:

Example 1 includes an apparatus comprising interface circuitry, machine-readable instructions, and at least one processor circuit to be programmed by the machine-readable instructions to determine a first schedule policy based on (a) an interval parameter and (b) an energy budget parameter, the first schedule policy to include a first instantiation window, determine performance metrics of a target processor circuit based on instantiating a workload with the first schedule policy, and generate a second schedule policy based on the performance metrics of the target processor circuit, the second schedule policy to include a second instantiation window, the second instantiation window including a modification relative to the first instantiation window.

Example 2 includes the apparatus as defined in example 1, wherein one or more of the at least one processor circuit is to identify an instantiation violation instance of the workload based on an instantiation timestamp that does not satisfy an instantiation threshold of the first instantiation window.

Example 3 includes the apparatus as defined in example 2, wherein the instantiation threshold is based on a type of the target processor circuit.

Example 4 includes the apparatus as defined in example 1, wherein one or more of the at least one processor circuit is to provide the performance metrics of the target processor to a scheduling circuit to generate the second workload.

Example 5 includes the apparatus as defined in example 4, wherein the scheduling circuit is associated with an operating system (OS).

Example 6 includes the apparatus as defined in example 5, wherein one or more of the at least one processor circuit is to provide a telemetry feed to the OS from (a) the target processor circuit, and (b) a power management circuit associated with the target processor circuit.

Example 7 includes the apparatus as defined in example 1, wherein one or more of the at least one processor circuit is to retrieve the energy budget parameter from a power management circuit associated with the target processor circuit.

Example 8 includes the apparatus as defined in example 7, wherein the power management circuit is to determine a rate of change of the energy budget.

Example 9 includes the apparatus as defined in example 8, wherein one or more of the at least one processor circuit is to generate the second workload based on the rate of change of the energy budget and the workload interval parameter.

Example 10 includes At least one non-transitory machine-readable medium comprising machine-readable instructions to cause at least one processor circuit to at least determine a first schedule policy based on (a) an interval parameter and (b) an energy budget parameter, the first schedule policy to include a first instantiation window, determine performance metrics of a target processor circuit based on instantiating a workload with the first schedule policy, and generate a second schedule policy based on the performance metrics of the target processor circuit, the second schedule policy to include a second instantiation window, the second instantiation window including a modification relative to the first instantiation window.

Example 11 includes the at least one non-transitory machine-readable medium as defined in example 10, wherein the machine-readable instructions are to cause one or more of the at least one processor circuit to identify an instantiation violation instance of the workload based on an instantiation timestamp that does not satisfy an instantiation threshold of the first instantiation window.

Example 12 includes the at least one non-transitory machine-readable medium as defined in example 11, wherein the machine-readable instructions are to cause one or more of the at least one processor circuit to determine the instantiation threshold based on a type of the target processor circuit.

Example 13 includes the at least one non-transitory machine-readable medium as defined in example 10, wherein the machine-readable instructions are to cause one or more of the at least one processor circuit to provide the performance metrics of the target processor to a scheduling circuit to generate the second workload.

Example 14 includes the at least one non-transitory machine-readable medium as defined in example 13, wherein the machine-readable instructions are to cause one or more of the at least one processor circuit to associate the scheduling circuit with an operating system (OS).

Example 15 includes the at least one non-transitory machine-readable medium as defined in example 14, wherein the machine-readable instructions are to cause one or more of the at least one processor circuit to provide a telemetry feed to the OS from (a) the target processor circuit, and (b) a power management circuit associated with the target processor circuit.

Example 16 includes the at least one non-transitory machine-readable medium as defined in example 10, wherein the machine-readable instructions are to cause one or more of the at least one processor circuit to retrieve the energy budget parameter from a power management circuit associated with the target processor circuit.

Example 17 includes the at least one non-transitory machine-readable medium as defined in example 16, wherein the machine-readable instructions are to cause one or more of the at least one processor circuit to determine a rate of change of the energy budget.

Example 18 includes the at least one non-transitory machine-readable medium as defined in example 17, wherein the machine-readable instructions are to cause one or more of the at least one processor circuit to generate the second workload based on the rate of change of the energy budget and the workload interval parameter.

Example 19 includes a method comprising determining, by at least one processor circuit programmed by at least one instruction, a first schedule policy based on (a) an interval parameter and (b) an energy budget parameter, the first schedule policy to include a first instantiation window, determining, by one or more of the at least one processor circuit, performance metrics of a target processor circuit based on instantiating a workload with the first schedule policy, and generate, by one or more of the at least one processor circuit, a second schedule policy based on the performance metrics of the target processor circuit, the second schedule policy to include a second instantiation window, the second instantiation window including a modification relative to the first instantiation window.

Example 20 includes the method as defined in example 19, further including identifying an instantiation violation instance of the workload based on an instantiation timestamp that does not satisfy an instantiation threshold of the first instantiation window.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
determine a first schedule policy based on (a) an interval parameter and (b) an energy budget parameter, the first schedule policy to include a first instantiation window;
determine performance metrics of a target processor circuit based on instantiating a workload with the first schedule policy; and
generate a second schedule policy based on the performance metrics of the target processor circuit, the second schedule policy to include a second instantiation window, the second instantiation window including a modification relative to the first instantiation window.

2. The apparatus as defined in claim 1, wherein one or more of the at least one processor circuit is to identify an instantiation violation instance of the workload based on an instantiation timestamp that does not satisfy an instantiation threshold of the first instantiation window.

3. The apparatus as defined in claim 2, wherein the instantiation threshold is based on a type of the target processor circuit.

4. The apparatus as defined in claim 1, wherein one or more of the at least one processor circuit is to provide the performance metrics of the target processor to a scheduling circuit to generate the second workload.

5. The apparatus as defined in claim 4, wherein the scheduling circuit is associated with an operating system (OS).

6. The apparatus as defined in claim 5, wherein one or more of the at least one processor circuit is to provide a telemetry feed to the OS from (a) the target processor circuit, and (b) a power management circuit associated with the target processor circuit.

7. The apparatus as defined in claim 1, wherein one or more of the at least one processor circuit is to retrieve the energy budget parameter from a power management circuit associated with the target processor circuit.

8. The apparatus as defined in claim 7, wherein the power management circuit is to determine a rate of change of the energy budget.

9. The apparatus as defined in claim 8, wherein one or more of the at least one processor circuit is to generate the second workload based on the rate of change of the energy budget and the workload interval parameter.

10. At least one non-transitory machine-readable medium comprising machine-readable instructions to cause at least one processor circuit to at least:
determine a first schedule policy based on (a) an interval parameter and (b) an energy budget parameter, the first schedule policy to include a first instantiation window;
determine performance metrics of a target processor circuit based on instantiating a workload with the first schedule policy; and
generate a second schedule policy based on the performance metrics of the target processor circuit, the second schedule policy to include a second instantiation window, the second instantiation window including a modification relative to the first instantiation window.

11. The at least one non-transitory machine-readable medium as defined in claim 10, wherein the machine-readable instructions are to cause one or more of the at least one processor circuit to identify an instantiation violation instance of the workload based on an instantiation timestamp that does not satisfy an instantiation threshold of the first instantiation window.

12. The at least one non-transitory machine-readable medium as defined in claim 11, wherein the machine-readable instructions are to cause one or more of the at least one processor circuit to determine the instantiation threshold based on a type of the target processor circuit.

13. The at least one non-transitory machine-readable medium as defined in claim 10, wherein the machine-readable instructions are to cause one or more of the at least one processor circuit to provide the performance metrics of the target processor to a scheduling circuit to generate the second workload.

14. The at least one non-transitory machine-readable medium as defined in claim 13, wherein the machine-readable instructions are to cause one or more of the at least one processor circuit to associate the scheduling circuit with an operating system (OS).

15. The at least one non-transitory machine-readable medium as defined in claim 14, wherein the machine-readable instructions are to cause one or more of the at least one processor circuit to provide a telemetry feed to the OS from (a) the target processor circuit, and (b) a power management circuit associated with the target processor circuit.

16. The at least one non-transitory machine-readable medium as defined in claim 10, wherein the machine-readable instructions are to cause one or more of the at least one processor circuit to retrieve the energy budget parameter from a power management circuit associated with the target processor circuit.

17. The at least one non-transitory machine-readable medium as defined in claim 16, wherein the machine-readable instructions are to cause one or more of the at least one processor circuit to determine a rate of change of the energy budget.

18. The at least one non-transitory machine-readable medium as defined in claim 17, wherein the machine-readable instructions are to cause one or more of the at least one processor circuit to generate the second workload based on the rate of change of the energy budget and the workload interval parameter.

19. A method comprising:
determining, by at least one processor circuit programmed by at least one instruction, a first schedule policy based on (a) an interval parameter and (b) an energy budget parameter, the first schedule policy to include a first instantiation window;
determining, by one or more of the at least one processor circuit, performance metrics of a target processor circuit based on instantiating a workload with the first schedule policy; and
generate, by one or more of the at least one processor circuit, a second schedule policy based on the performance metrics of the target processor circuit, the second schedule policy to include a second instantiation window, the second instantiation window including a modification relative to the first instantiation window.

20. The method as defined in claim 19, further including identifying an instantiation violation instance of the workload based on an instantiation timestamp that does not satisfy an instantiation threshold of the first instantiation window.
